(19) United States
(12) Patent Application Publication
(10) Pub. No.: US 2024/0075446 A1
(43) Pub. Date: Mar. 7, 2024

(54) DEVICE FOR REMOVING IRON FROM NICKEL-COBALT-MANGANESE SULFURIC ACID SOLUTION AND METHOD FOR CONTINUOUSLY REMOVING IRON IONS FROM NICKEL-COBALT-MANGANESE SULFURIC ACID SOLUTION AT LOW TEMPERATURE

(71) Applicant: HUNAN JIN YUAN NEW MATERIALS JOINT STOCK COMPANY LIMITED, Yiyang (CN)

(72) Inventors: Xunbing LIU, Yiyang (CN); Can PENG, Yiyang (CN); Zhen LIU, Yiyang (CN); Quncheng ZHOU, Yiyang (CN); Zi WANG, Yiyang (CN); Xiongwu DONG, Yiyang (CN); Shanmu WU, Yiyang (CN); Jianjun OUYANG, Yiyang (CN)

(21) Appl. No.: 18/487,944

(22) Filed: Oct. 16, 2023

Related U.S. Application Data
(63) Continuation of application No. PCT/CN2022/088140, filed on Apr. 21, 2022.

(30) Foreign Application Priority Data
Apr. 25, 2021 (CN) 202110446037.7

(51) Int. Cl. B01J 19/00; C01G 49/00

(52) U.S. Cl. CPC B01J 19/0066; B01J 19/0086; C01G 49/00; B01J 2219/00177

(57) ABSTRACT

A device for removing iron from a nickel-cobalt-manganese sulfuric acid solution and a method for continuously removing iron ions from a nickel-cobalt-manganese sulfuric acid solution. The device has an iron removal reactor (2) having a stirrer (3) and an iron removal reactor inner cylinder (5) and an aging reactor (9) having an aging reactor stirrer (7) and an automatic stone powder feeder (8), a mixing feed pipe (12) and a carbonate solution feed pipe (4) are arranged in an interlayer between the iron removal reactor (2) and the iron removal reactor inner cylinder (5), a mixer (1) for a preheating the device is arranged at a top of the mixing feed pipe (12), a compressed air inlet (11) and a feed inlet (10) of a solution to be subjected to iron removal are arranged in the mixer (1). Further disclosed is a method for removing iron of the device.

### CROSS-REFERENCE TO RELATED APPLICATIONS

This application is a continuation of International Patent Application No. PCT/CN2022/088140 with a filing date of Apr. 21, 2022, designating the United States, now pending, and further claims priority to Chinese Patent Application No. 202110446037.7 with a filing date of Apr. 25, 2021. The content of the aforementioned applications, including any intervening amendments thereto, are incorporated herein by reference.

### TECHNICAL FIELD

The present invention belongs to the technical field of non-ferrous metal hydrometallurgy, and particularly relates to a method for removing iron from a nickel-cobalt-manganese sulfuric acid solution.

### BACKGROUND OF THE PRESENT INVENTION

In industrial production, goethite and sodium jarosite methods are commonly used to remove iron from a solution. These two methods need to be carried out at a high temperature of 85° C. or above, and an oxidant needs to be added in the process to control a valence state of iron ions in the solution. In addition, it is also necessary to satisfy that the solution contains other ions with a certain concentration, such as sodium and ammonium. In the above two iron removal methods, various reagents are added step by step in the operation process and a certain reaction time needs to be controlled, and generally, it can only be single-tank operation. For example, the patent with the publication number CN111187922A and the publication date May 22, 2020 is a method for selectively leaching nickel from high-nickel copper matte under a normal pressure, and the disclosed technology comprises: removing iron from a leaching solution: returning the leaching solution obtained in the step (1) to be continuously leached until an iron ion concentration in the leaching solution is 30 g/L to 36 g/L, then adding hydrogen peroxide and potassium sulfate into the leaching solution, and filtering to obtain an iron-removed solution and a removed iron slag, wherein the iron-removed solution is a nickel sulfate solution, and the removed iron slag is washed with water and filtered to obtain an iron vitriol slag. A use amount of hydrogen peroxide is twice as much as a theoretical amount needed for a reaction with iron, a use amount of potassium sulfate is 1.2 times as much as the theoretical amount needed for the reaction with iron, an iron removal temperature is 90° C. to 95° C., and an iron removal time is 2 hours to 4 hours. Not only the iron removal temperature is high and a lot of energy is consumed, but also the reaction time is long and the production efficiency is low. Meanwhile, a lot of hydrogen peroxide and a lot of potassium sulfate are also consumed, leading to a high production cost.

### SUMMARY OF PRESENT INVENTION

### Technical Problem

The present invention aims to overcome the shortcomings and defects in the above background and to disclose a device for removing iron from a nickel-cobalt-manganese sulfuric acid solution and a method for continuously removing iron ions from a nickel-cobalt-manganese sulfuric acid solution at a low temperature, with the advantages of low iron removal temperature, low energy consumption, high production efficiency, no need to use auxiliary materials such as hydrogen peroxide and potassium sulfate and low production cost.

### Solution of Problem

### Technical Solution

A first technical solution of the present invention is that: a device for removing iron from a nickel-cobalt-manganese sulfuric acid solution is provided with an iron removal reactor and an aging reactor, a first stirrer is arranged in the iron removal reactor, a second stirrer is arranged in the aging reactor, and the iron removal reactor is connected with the aging reactor by an overflow port connecting pipe, wherein an iron removal reactor inner cylinder is arranged in the iron removal reactor, a mixing feed pipe and a carbonate solution feed pipe are arranged in an interlayer between the iron removal reactor and the iron removal reactor inner cylinder, a mixer is arranged at a top portion of the mixing feed pipe, a compressed air inlet and a feed inlet of a solution to be subjected to iron removal are arranged in the mixer, and an automatic stone powder feeder is arranged on the aging reactor.

Further, the mixer is provided with a mixing bin, the mixing bin has a trapezoidal structure with a larger upper portion and a smaller lower portion, the lower portion of the mixing bin is provided with an electric heating portion, the compressed air inlet is arranged in a top portion of the mixing bin, the feed inlet of the solution to be subjected to iron removal is arranged in a side surface of the mixing bin, so that the solution to be subjected to iron removal is tangent to compressed air from the side surface, a diameter of an outlet in a bottom portion of the mixing bin is ½ of a diameter of the bottom portion of the mixing bin, the outlet in the bottom portion of the mixing bin is connected with the mixing feed pipe, and the mixing feed pipe penetrates through the electric heating portion.

Further, a height of the mixing bin accounts for 25% to 35% of a height of the whole mixer, preferably 30%. The function is that: the mixed material is controlled to have a certain heating and heat preservation time in the mixer, and if the height is increased and the heating time is reduced, a heating effect may be affected.

Further, a bottom end of the mixing feed pipe is 30 cm to 40 cm away from a bottom surface of the iron removal reactor, preferably 35 cm, and a direction of an outlet of the mixing feed pipe is tangent to a stirring direction of the first stirrer. The function is that: on one hand, an inlet of the mixed material is lower than a stirring vane, and the mixing is strengthened under a pumping force of the stirring vane; and on the other hand, the inlet of the mixed material is tangent to the stirring direction, which is beneficial for rapid mixing of a new material with the material in the reactor, thus increasing a reaction speed.

Further, the mixing feed pipe is symmetrically arranged with the carbonate solution feed pipe. The function is that: the mixed solution and the carbonate solution are symmetrically distributed, which is mainly intended to have a certain reaction time under a stirring state and better PH stability, and if the two solutions are too close, there may be an area with too high PH value in the reactor, leading to a loss of main element.

Further, a height-diameter ratio of the iron removal reactor is 1.0 to 2.5:1, preferably 1.5 to 2.0:1. The function is that: the height-diameter ratio mainly considers that after the mixed solution reacts with the carbonate at the bottom portion of the reactor, the solution can only flow out of an overflow port to the aging reactor after maintaining a certain reaction time in the reactor under an action of a stirring force.

Further, the first stirrer is composed of a motor and a stirring vane, the stirring vane adopts a cross-shaped double-layer stirring blade, a maximum diameter of the stirring blade is ⅓ of a diameter of the iron removal reactor, a lowermost stirring blade is 50 cm to 80 cm away from a bottom portion of the reactor, preferably 60 cm to 70 cm, and a distance between upper and lower stirring blades is 50 cm to 115 cm, preferably 60 cm to 100 cm, 70 cm to 90 cm, and 80 cm. The function is that: the distance between the blade and the bottom portion is intended to maintain the blade above the inlet of the mixed solution and the carbonate solution, a length of the blade mainly ensures a stirring intensity, and if the length is too long, a load of the motor is increased on one hand, and the excessive stirring intensity may cause a very disordered fluid in the reactor, thus affecting a mixing effect. The distance between the two layers of stirring blades is intended to maintain a certain stirring intensity, if the distance is too small, there may be insufficient mixing intensity at the upper portion of the reactor, while if the distance is too large, upper and lower laminar flows may be caused, and the reaction is uneven, which is not beneficial for the iron removal reaction.

Further, the carbonate solution feed pipe is 30 cm to 40 cm away from the bottom surface of the iron removal reactor, preferably 35 cm, and a direction of an outlet of the carbonate solution feed pipe is tangent to the stirring direction of the first stirrer. The function is that: on one hand, an inlet of the carbonate solution is lower than a stirring vane, and the mixing is strengthened under a pumping force of the stirring vane; and on the other hand, the inlet of the carbonate solution is tangent to the stirring direction, which is beneficial for rapid mixing of a new material with the material in the reactor, thus increasing a reaction speed.

Further, the iron removal reactor inner cylinder is made into a cylindrical shape with open top and bottom portions, and fixed on an inner wall of the iron removal reactor by a connecting plate, and a diameter of the inner cylinder is 70% to 80% of a diameter of the iron removal reactor. The function is that: the reactor inner cylinder is used to control the fluid in the reactor to circulate up and down, and the mixed solution and the carbonate solution are upwardly mixed and lifted up from the bottom portion under an action of a stirring and pumping force, so as to flow into a gap between an exterior of a cylinder body and a wall of the reactor from an upper end of the cylinder body, move down under driving of a whole fluid in a reaction tank, and then enter a stirring state from a bottom portion of the cylinder body again, thus forming a circulating fluid movement state.

Further, the second stirrer is composed of a motor and a stirring vane, the stirring vane adopts a cross-shaped double-layer stirring blade, a diameter of the stirring blade is ⅓ of a diameter of the aging reactor, a lowermost stirring blade is 50 cm to 80 cm away from a bottom portion of the reactor, preferably 60 cm to 70 cm, and a distance between upper and lower stirring blades is 50 cm to 115 cm, preferably 60 cm to 100 cm, 70 cm to 90 cm, and 80 cm. The function is that: the reactor is the aging reactor and maintains the same parameters as the iron removal reactor, but a stirring speed of the aging reactor is much lower than a stirring speed of the iron removal reactor. The distance between the blade and the bottom portion is intended to ensure that solid particles may not deposit on a bottom portion of the reaction tank during aging, and if the distance is too large, there may be deposition, while if the distance is too small, the load of the motor can be increased. A function of the diameter of the blade is basically the same as the function of the distance between the blade and the bottom portion, and if the diameter is too small, the solid particles are easy to deposit, while if the diameter is too large, the load of the motor can be increased. The distance between the two blades mainly maintains a certain stirring intensity, and if the distance is too small, the stirring intensity at the upper portion is lower, while if the distance is too large, upper and lower stirring laminar flows may be formed, which is not beneficial for the aging reaction.

Further, the automatic stone powder feeder is automatically controlled by an electromagnetic valve, and a feeding speed and a feeding amount are controlled by input for automatic feeding.

According to the present invention, because the mixer 1 is provided with the mixing bin, and the mixing bin has the trapezoidal structure with the larger upper portion and the smaller lower portion, the compressed air is directly sprayed from the top portion, the solution to be subjected to iron removal is tangent to the compressed air from the side surface, a pressure in the mixing bin is suddenly increased, a mixing intensity is greatly enhanced, the outlet in the bottom portion of the mixing bin is continuously narrowed, which is ½ of the diameter of the bottom portion of the mixing bin, and in addition, the electric heating portion is arranged at the lower portion of the mixing bin, so that the compressed air and the solution to be subjected iron removal enter the reactor in a microbubble-like jet after being heated, which accelerates oxidation of ferrous iron.

A second technical solution of the present invention is that: a method for continuously removing iron ions from a nickel-cobalt-manganese sulfuric acid solution at a low temperature by using a device for removing iron from a nickel-cobalt-manganese sulfuric acid solution comprises the following steps of: a. preparing carbonate: preparing a carbonate solution or slurry first, wherein a carbonate concentration is 120 g/L to 240 g/L, and a temperature is controlled to be 40° C. to 45° C.;

b. injecting a solution to be subjected to iron removal: injecting a nickel-cobalt-manganese sulfuric acid solution to be subjected to iron removal and compressed air into an iron removal reactor through a mixer with a preheating device;

c. injecting the carbonate solution: adding the prepared carbonate solution or slurry into the iron removal reactor while injecting the nickel-cobalt-manganese sulfuric acid solution to be subjected to iron removal, and controlling a PH value of a process reaction to be 2.5 to 3.5;

d. carrying out a stirring reaction: when the solution to be subjected to iron removal and the carbonate solution are injected, stirring the mixture during injecting, controlling a process temperature to be 40° C. to 45° C., and after the reactor is full, making the reaction slurry enter the aging reactor;

e. adding stone powder: after the reaction slurry enters the aging reactor, stirring the slurry, and then adding the stone powder (with a principal component of calcium carbonate) through an automatic feed device; and

f. filtering the solution: filtering the solution after the aging reactor is full, wherein a filter residue is an iron slag, and a filtrate is the iron-removed nickel-cobalt-manganese sulfuric acid solution.

Further, the carbonate is one or more of cobalt carbonate, nickel carbonate, manganese carbonate and sodium carbonate.

Further, the concentration of the prepared carbonate is 130 g/L to 220 g/L, preferably 140 g/L to 200 g/L, 150 g/L to 180 g/L, and 160 g/L to 170 g/L, or 120 g/L to 130 g/L, 130 g/L to 140 g/L, 140 g/L to 150 g/L, 150 g/L to 160 g/L, 160 g/L to 170 g/L, 170 g/L to 180 g/L, 180 g/L to 190 g/L, 190 g/L to 200 g/L, 200 g/L to 210 g/L, 210 g/L to 220 g/L and 220 g/L to 230 g/L.

Further, the temperature of the prepared carbonate is controlled to be 40° C. to 45° C., and may also be 41° C. to 42° C., and 43° C. to 44° C.

Further, in the step of injecting the iron solution to be subjected to iron removal, a flow rate of the solution is calculated according to a volume of the reactor by the following formula: flow rate=volume V of reactor m³/(2-5.5 hours), and a flow rate of the compressed air is 2 to 8 times that of the iron solution to be subjected to iron removal, preferably 3 to 7 times, 4 to 6 times, and 5 times.

The flow rate in this step is controlled to realize full reaction to produce iron hydroxide in a retention time, which is namely the reaction time, in the iron removal reactor to remove iron from the solution; and the flow rate of the compressed air determines a degree of oxidation reaction. Experimental data are shown in Table 1 and Table 2.

TABLE 1
Comparison table of iron removal from solution at flow rates
of 24.72 m³ reactor under 5 times of compressed air

| | | | | | | | | | |
|---|---|---|---|---|---|---|---|---|---|
| Flow rate of | 13 | 16 | 14 | 12 | 10 | 3 | 6 | 5 | 4 |
| solution to be | | | | | | | | | |
| subjected to iron | | | | | | | | | |
| removal (mA) | | | | | | | | | |
| Retention time | 1.37 | 1.55 | 1.77 | 2.06 | 2.47 | 3.09 | 4.12 | 4.94 | 6.18 |
| (hour) | | | | | | | | | |
| Iron content | 5.22 | 5.22 | 5.22 | 5.22 | 5.22 | 5.22 | 5.22 | 5.22 | 5.22 |
| before iron | | | | | | | | | |
| removal (g/L) | | | | | | | | | |
| Iron content after | 0.174 | 0.093 | 0.075 | 0.013 | 0.006 | 0.002 | 10.002 | 0.002 | 0.001 |
| iron removal (g/L) | | | | | | | | | |
| Iron removal rate | 96.67 | 98.22 | 93.56 | 99.75 | 99.89 | 99.96 | 99.96 | 99.96 | 99.98 |
| (%) | | | | | | | | | |

TABLE 2
Comparison table of iron removal from solution at flow rates
of compressed air of 24.72 m³ reactor under flow rate of 8 m³/h

| | | | | | | | | | |
|---|---|---|---|---|---|---|---|---|---|
| Flow rate of | 8 | 16 | 24 | 32 | 40 | 48 | 56 | 64 | 72 |
| compressed air | | | | | | | | | |
| (mA) | | | | | | | | | |
| Times | 1 | 2 | 3 | 4 | 5 | 6 | 7 | 8 | 9 |
| Iron content | 3.04 | 3.04 | 3.04 | 3.04 | 3.04 | 3.04 | 3.04 | 3.04 | 3.04 |
| before iron | | | | | | | | | |
| removal (g/L) | | | | | | | | | |
| Iron content after | 0.087 | 0.013 | 0.007 | 0.003 | 0.003 | 0.002 | 0.002 | 10.002 | 0.002 |
| iron removal (g/L) | | | | | | | | | |
| Iron removal rate | 97.14 | 99.57 | 99.76 | 99.90 | 99.90 | 99.93 | 99.93 | 99.93 | 99.93 |
| (%) | | | | | | | | | |

Further, in the step of injecting the solution to be subjected to iron removal, the temperature of the preheating device is controlled to be 40° C. to 45° C., and may also be 41° C. to 42° C., and 43° C. to 44° C.

Further, the addition amount of the stone powder in per cubic meter of solution is 0.05 kg/m³ to 0.5 kg/m³, preferably 0.10 kg/m³ to 0.45 kg/m³, 0.15 kg/m³ to 0.40 kg/m³, 0.20 kg/m³ to 0.35 kg/m³, and 0.25 kg/m³ to 0.30 kg/m³.

This step is intended to make a produced iron hydroxide precipitate produce a mixed slag with a good filtration performance under an action of calcium powder during the aging process, and experimental data are shown in Table 3.

TABLE 3
Comparison table of filtration time under different addition
amounts of calcium

| | | | | | | | | | | | | |
|---|---|---|---|---|---|---|---|---|---|---|---|---|
| Addition amount of | 0.01 | 0.05 | 0.10 | 0.15 | 0.20 | 0.25 | 0.30 | 0.35 | 0.40 | 0.45 | 0.50 | 0.55 |
| calcium (kg/m³) | | | | | | | | | | | | |
| Filtration time (min/m³) | 65 | 31 | 23 | 17 | 12 | 11 | 11 | 8 | 8 | 5 | 5 | 5 |

According to the present invention, at a low temperature of 40° C. to 45° C., the solution to be subjected to iron removal (the nickel-cobalt-manganese sulfuric acid solution) and the carbonate solution or slurry are continuously added into the iron removal reactor in a parallel flow manner, a lot of microbubbles are produced by the compressed air and the solution to be subjected to iron removal under certain proportion and pressure, ferrous iron ions in the solution are oxidized into ferric iron ions, and under the action of carbonate, a precipitate of Fe(OH), is produced when a PH value is increased; and after the iron removal reactor is full of the slurry, the slurry continuously flows into the aging reactor, by using the aging and calcium adding technology, particles of a produced iron hydroxide colloid are enlarged during the aging process and a surface is modified, and the colloid forms the mixed slag with the good filtration performance with added calcium, so as to remove iron.

### Beneficial Effects of Invention

### Beneficial Effects

Due to the adoption of the above technical solutions, the present invention has the following advantages. (1) The iron removal is carried out at the low temperature of 40° C. to 45° C., which has low requirement for apparatus and saves energy.

(2) Continuous production can be realized by adding in the parallel flow manner, and efficiency of energy production is greatly improved.

(3) The compressed air and the solution to be subjected to iron removal are used for pressure-strengthened mixing, a lot of microbubbles are produced in the process, and the ferrous iron ions are oxidized into the ferric iron ions without adding the oxidant.

(4) By using the aging and calcium adding technology, the particles of the produced iron hydroxide colloid are enlarged during the aging process and the surface is modified, and the colloid forms the mixed slag with the good filtration performance with added calcium.

(5) The iron removal rate is above 99.5%.

### DESCRIPTION OF THE DRAWINGS

### Description of the Drawings

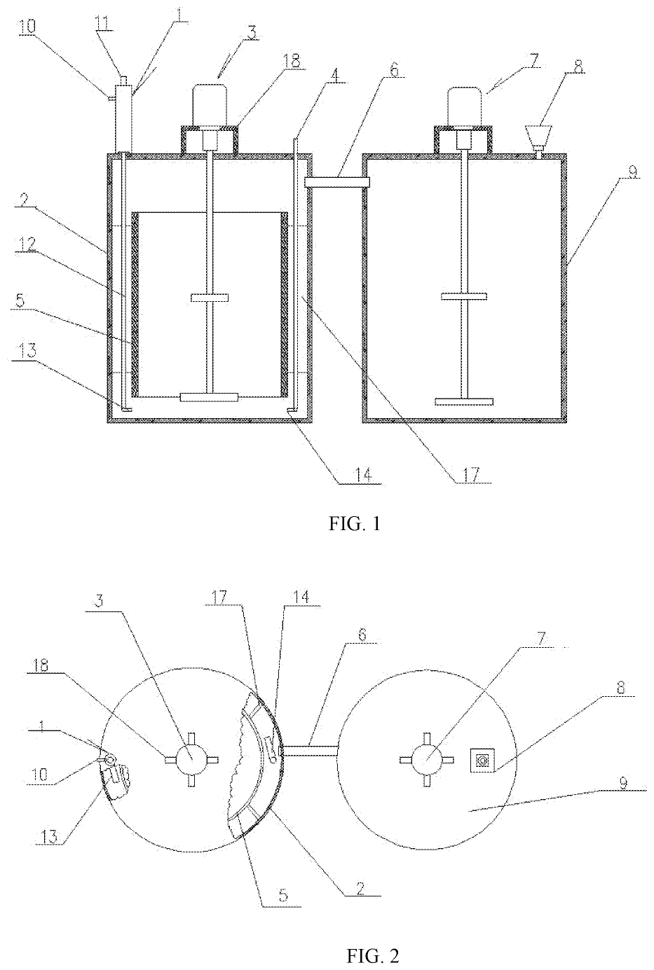

FIG. 1 is a schematic diagram of a front-view sectional structure of a device for removing iron of the present invention.

FIG. 2 is a schematic diagram of a top-view structure of the device for removing iron of the present invention.

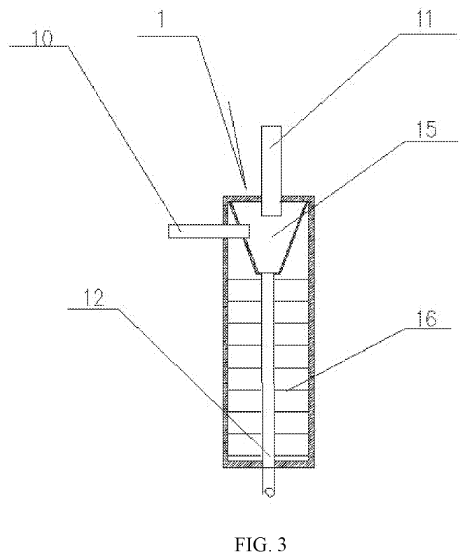

FIG. 3 is an enlarged diagram of a structure of a mixer of the present invention.

### DESCRIPTION OF REFERENCE NUMERALS

1 refers to mixer, 2 refers to iron removal reactor, 3 refers to first mixer, 4 refers to carbonate solution feed pipe, 5 refers to iron removal reactor inner cylinder, 6 refers to overflow port connecting pipe, 7 refers to second mixer, 8 refers to automatic stone powder feeder, 9 refers to aging reactor, 10 refers to feed inlet of solution to be subjected to iron removal, 11 refers to compressed air inlet, 12 refers to mixing feed pipe, 13 refers to outlet of mixing feed pipe, 14 refers to outlet of carbonate solution feed pipe, 15 refers to mixing bin, 16 refers to heating portion, 17 refers to connecting plate, and 18 refers to support.

### OPTIMAL EMBODIMENTS FOR IMPLEMENTING THE PRESENT INVENTION

### Optimal Implementations of the Present Invention

A method for continuously removing iron ions from a nickel-cobalt-manganese sulfuric acid solution at a low temperature by using a device for removing iron from a nickel-cobalt-manganese sulfuric acid solution comprises the following steps of: a. preparing carbonate: preparing a carbonate solution or slurry first, wherein a carbonate concentration is 220 g/L, and a temperature is controlled to be 45° C.;

b. injecting a solution to be subjected to iron removal: injecting a nickel-cobalt-manganese sulfuric acid solution to be subjected to iron removal and compressed air into an iron removal reactor through a mixer with a preheating device;

c. injecting the carbonate solution: adding the prepared carbonate solution or slurry into the iron removal reactor while injecting the nickel-cobalt-manganese sulfuric acid solution to be subjected to iron removal, and controlling a PH value of a process reaction to be 3.0;

d. carrying out a stirring reaction: when the solution to be subjected to iron removal and the carbonate solution are injected, stirring the mixture during injecting, controlling a process temperature to be 45° C., and after the reactor is full, making the reaction slurry enter the aging reactor;

e. adding stone powder: after the reaction slurry enters the aging reactor, stirring the slurry, and then adding the stone powder (with a principal component of calcium carbonate) through an automatic feed device; and

f. filtering the solution: filtering the solution after the aging reactor is full, wherein a filter residue is an iron slag, and a filtrate is the iron-removed nickel-cobalt-manganese sulfuric acid solution.

A device for removing iron from a nickel-cobalt-manganese sulfuric acid solution is provided with an iron removal reactor and an aging reactor, a first stirrer is arranged in the iron removal reactor, a second stirrer is arranged in the aging reactor, and the iron removal reactor is connected with the aging reactor by an overflow port connecting pipe, wherein an iron removal reactor inner cylinder is arranged in the iron removal reactor, a mixing feed pipe and a carbonate solution feed pipe are arranged in an interlayer between the iron removal reactor and the iron removal reactor inner cylinder, a mixer is arranged at a top portion of the mixing feed pipe, a compressed air inlet and a feed inlet of a solution to be subjected to iron removal are arranged in the mixer, and an automatic stone powder feeder is arranged on the aging reactor. The mixer is provided with a mixing bin, the mixing bin has a trapezoidal structure with a larger upper portion and a smaller lower portion, the lower portion of the mixing bin is provided with an electric heating portion, the compressed air inlet is arranged in a top portion of the mixing bin, the feed inlet of the solution to be subjected to iron removal is arranged in a side surface of the mixing bin, so that the solution to be subjected to iron removal is tangent to compressed air from the side surface, a diameter of an outlet in a bottom portion of the mixing bin is ½ of a diameter of the bottom portion of the mixing bin, the outlet in the bottom portion of the mixing bin is connected with the mixing feed pipe, and the mixing feed pipe penetrates through the electric heating portion. A height of the mixing bin accounts for 30% of a height of the whole mixer. A bottom end of the mixing feed pipe is 35 cm away from a bottom surface of the iron removal reactor, and a direction of an outlet of the mixing feed pipe is tangent to a stirring direction of the first stirrer. The mixing feed pipe is symmetrically arranged with the carbonate solution feed pipe. A height-diameter ratio of the iron removal reactor is 1.5 to 2.0:1. The first stirrer is composed of a motor and a stirring vane, the stirring vane adopts a cross-shaped double-layer stirring blade, a maximum diameter of the stirring blade is ⅓ of a diameter of the iron removal reactor, a lowermost stirring blade is 60 cm to 70 cm away from a bottom portion of the reactor, and a distance between upper and lower stirring blades is 80 cm to 100 cm. The carbonate solution feed pipe is 35 cm away from the bottom surface of the iron removal reactor, and a direction of an outlet of the carbonate solution feed pipe is tangent to the stirring direction of the first stirrer. The iron removal reactor inner cylinder is made into a cylindrical shape with open top and bottom portions, and fixed on an inner wall of the iron removal reactor by a connecting plate, and a diameter of the inner cylinder is 70% to 80% of a diameter of the iron removal reactor. The second stirrer is composed of a motor and a stirring vane, the stirring vane adopts a cross-shaped double-layer stirring blade, a diameter of the stirring blade is ⅓ of a diameter of the aging reactor, a lowermost stirring blade is 60 cm to 70 cm away from a bottom portion of the reactor, and a distance between upper and lower stirring blades is 80 cm to 100 cm.

### DETAILED DESCRIPTION OF PREFERRED EMBODIMENTS

### Implementations of the Present Invention

In order to understand the present invention more clearly, the present invention is further described hereinafter by embodiments with reference to FIG. 1 to FIG. 3.

Embodiment 1: A device for removing iron from a nickel-cobalt-manganese sulfuric acid solution is provided with an iron removal reactor 2 and an aging reactor 9, a first stirrer 3 is arranged in the iron removal reactor 2, a second stirrer 7 is arranged in the aging reactor 9, and the iron removal reactor 2 is connected with the aging reactor 9 by an overflow port connecting pipe 5. An iron removal reactor inner cylinder 5 is arranged in the iron removal reactor 2, a mixing feed pipe 12 and a carbonate solution feed pipe 4 are arranged in an interlayer between the iron removal reactor 2 and the iron removal reactor inner cylinder 5, a mixer 1 is arranged at a top portion of the mixing feed pipe 12, a compressed air inlet 11 and a feed inlet 10 of a solution to be subjected to iron removal are arranged in the mixer 1, and an automatic stone powder feeder 8 is arranged on the aging reactor 9. The mixer 1 is provided with a mixing bin 15, the mixing bin 15 has a trapezoidal structure with a wide upper portion and a narrow lower portion, the compressed air inlet 11 is arranged at a top portion of the mixing bin 15, the compressed air is directly sprayed from the top portion, the feed inlet 10 of the solution to be subjected to iron removal is arranged on a side surface of the mixing bin 15, the solution to be subjected to iron removal is tangent to the compressed air from the side surface, and a diameter of an outlet in the bottom portion of the mixing bin 15 is ½ of a diameter of a bottom portion of the mixing bin, so that the compressed air and the solution to be subjected iron removal enter the iron removal reactor 2 in a microbubble-like jet. The lower portion of the mixing bin 15 is provided with an electric heating portion 16, the outlet in the bottom portion of the mixing bin 15 is connected with the mixing feed pipe 12, and the mixing feed pipe 12 penetrates through the electric heating portion 16. The mixing bin 15 accounts for 25% to 35% of a length of the whole mixer 1.

In Embodiment 1, a simple apparatus structure and a low manufacturing cost are achieved, continuous production can be realized due to the process, intermediate pause time is omitted, production efficiency is greatly improved, and a production capacity is correspondingly improved.

Embodiment 2: A device for removing iron from a nickel-cobalt-manganese sulfuric acid solution is provided with an iron removal reactor 2 and an aging reactor 9, and a height-diameter ratio of the iron removal reactor 2 is 1:1. A first stirrer 3 is arranged in the iron removal reactor 2. The first stirrer 3 is composed of a motor and a stirring vane, the stirring vane adopts a cross-shaped double-layer stirring blade, a diameter of the stirring blade is ⅓ of a diameter of the iron removal reactor 2, a lowermost stirring blade is 50 cm away from a bottom portion of the reactor, and a distance between upper and lower stirring blades is 50 cm. A second stirrer 7 is arranged in the aging reactor 9. The second stirrer 7 is composed of a motor and a stirring vane, the motor is fixed on a support 18, the stirring vane adopts a cross-shaped double-layer stirring blade, a diameter of the stirring blade is ⅓ of a diameter of the aging reactor 9, a lowermost stirring blade is 50 cm away from a bottom portion of the reactor, and a distance between upper and lower stirring blades is 50 cm. The iron removal reactor 2 is connected with the aging reactor 9 by an overflow port connecting pipe 5, and an iron removal reactor inner cylinder 5 is arranged in the iron removal reactor 2. The iron removal reactor inner cylinder 5 is made into a cylindrical shape with open top and bottom portions, and fixed on an inner wall of the iron removal reactor 2 by a connecting plate 17, and a diameter of the inner cylinder is 70% of a diameter of the iron removal reactor 2. A mixing feed pipe 12 and a carbonate solution feed pipe 4 are arranged in an interlayer between the iron removal reactor 2 and the iron removal reactor inner cylinder 5, and the mixing feed pipe 12 is symmetrically arranged with the carbonate solution feed pipe 4. A bottom end of the mixing feed pipe 12 is 30 cm away from a bottom surface of the iron removal reactor 2, and a direction of an outlet of the mixing feed pipe 12 is tangent to a stirring direction of the first stirrer 3. The carbonate solution feed pipe 4 is 30 cm away from the bottom surface of the iron removal reactor 2, and a direction of an outlet of the carbonate solution feed pipe 4 is tangent to the stirring direction of the first stirrer 3. A mixer 1 for a preheating the device is arranged at a top portion of the mixing feed pipe 12, a compressed air inlet 11 and a feed inlet 10 of a solution to be subjected to iron removal are arranged in the mixer 1, and an automatic stone powder feeder 8 is arranged on the aging reactor 9. The automatic stone powder feeder 8 is automatically controlled by an electromagnetic valve, and a feeding speed and a feeding amount are controlled by input for automatic feeding. The automatic stone powder feeder 8 adopts a pneumatic knife gate valve produced by Shanghai Best Automation Technology Co., Ltd. for controlled feeding, and a model of the gate valve is QZ41-50CPV24-DXZ43.

In Embodiment 2, the continuous iron removal production can be realized by linkage operation of the reactor and the aging reactor, a simple apparatus structure and a low manufacturing cost are achieved, continuous production can be realized due to the process, intermediate pause time is omitted, production efficiency is greatly improved, and a production capacity is correspondingly improved.

Embodiment 3: A device for removing iron from a nickel-cobalt-manganese sulfuric acid solution is provided with an iron removal reactor 2 and an aging reactor 9, and a height-diameter ratio of the iron removal reactor 2 is 2.5:1. A first stirrer 3 is arranged in the iron removal reactor 2. The first stirrer 3 is composed of a motor and a stirring vane, the stirring vane adopts a cross-shaped double-layer stirring blade, a diameter of the stirring blade is ⅓ of a diameter of the iron removal reactor 2, a lowermost stirring blade is 80 cm away from a bottom portion of the reactor, and a distance between upper and lower stirring blades is 115 cm. A second stirrer 7 is arranged in the aging reactor 9. The second stirrer 7 is composed of a motor and a stirring vane, the motor is fixed on a support 18, the stirring vane adopts a cross-shaped double-layer stirring blade, a diameter of the stirring blade is ⅓ of a diameter of the aging reactor 9, a lowermost stirring blade is 80 cm away from a bottom portion of the reactor, and a distance between upper and lower stirring blades is 115 cm. The iron removal reactor 2 is connected with the aging reactor 9 by an overflow port connecting pipe 5, and an iron removal reactor inner cylinder 5 is arranged in the iron removal reactor 2. The iron removal reactor inner cylinder 5 is made into a cylindrical shape with open top and bottom portions, and fixed on an inner wall of the iron removal reactor 2 by a connecting plate 17, and a diameter of the inner cylinder is 80% of a diameter of the iron removal reactor 2. A mixing feed pipe 12 and a carbonate solution feed pipe 4 are arranged in an interlayer between the iron removal reactor 2 and the iron removal reactor inner cylinder 5, and the mixing feed pipe 12 is symmetrically arranged with the carbonate solution feed pipe 4. A bottom end of the mixing feed pipe 12 is 40 cm away from a bottom surface of the iron removal reactor 2, and a direction of an outlet of the mixing feed pipe 12 is tangent to a stirring direction of the first stirrer 3. The carbonate solution feed pipe 4 is 40 cm away from the bottom surface of the iron removal reactor 2, and a direction of an outlet of the carbonate solution feed pipe 4 is tangent to the stirring direction of the first stirrer 3. A mixer 1 for a preheating the device is arranged at a top portion of the mixing feed pipe 12, a compressed air inlet 11 and a feed inlet 10 of a solution to be subjected to iron removal are arranged in the mixer 1, and an automatic stone powder feeder 8 is arranged on the aging reactor 9. The automatic stone powder feeder 8 is automatically controlled by an electromagnetic valve, and a feeding speed and a feeding amount are controlled by input for automatic feeding. The automatic stone powder feeder 8 adopts a pneumatic knife gate valve produced by Shanghai Best Automation Technology Co., Ltd. for controlled feeding, and a model of the gate valve is QZ41-50CPV24-DXZ43.

In Embodiment 3, the continuous iron removal production can be realized by linkage operation of the reactor and the aging reactor, a simple apparatus structure and a low manufacturing cost are achieved, continuous production can be realized due to the process, intermediate pause time is omitted, production efficiency is greatly improved, and a production capacity is correspondingly improved.

Embodiment 4: A method for continuously removing iron ions from a nickel-cobalt-manganese sulfuric acid solution at a low temperature by using a device for removing iron from a nickel-cobalt-manganese sulfuric acid solution comprised the following steps. a. Components of the nickel-cobalt-manganese sulfuric acid solution to be subjected to iron removal were: Fe: 1.15 g/L, Co: 26.03 g/L, Mn: 5.41 g/L and Ni: 7.35 g/L. b. 124 g/L manganese carbonate slurry was prepared, and heat preservation was carried out at 45° C. c. An iron removal reactor 2 and an aging reactor 9 both had a diameter of 3 m, a height of 4 m and an effective volume of 24.72 m³. d. A mixer 1 was started, the solution to be subjected to iron removal, compressed air and the manganese carbonate slurry were injected at the same time, a flow rate of the solution to be subjected to iron removal was 10.5 m³/h, and a flow rate of the compressed air was 21 m³/h. e. A temperature in the mixer was controlled to be 45° C., a temperature in the reactor was controlled to be 45° C., and a reaction PH value was controlled to be 3.05. f. After the iron removal reactor 2 was full, the solution flowed into the aging reactor 9, an automatic stone powder feeder 8 was started, and 5 kg of stone powder was controlled to be added every hour. g. After the aging reactor 9 was full, a filtering device was started for filtering, the device for removing iron reached a balance at the moment, and the materials could be continuously fed and discharged, thus realizing continuous production. h. Components of the iron-removed solution were analyzed and detected to be as follows: Fe: 0.0055 g/L, Co: 25.99 g/L, Mn: 11.13 g/L and Ni: 7.05 g/L.

In Embodiment 4, the problem that an existing technology for removing iron from solution must be used for removing iron at a high temperature of 85° C. or above is overcome, the iron removal of the solution can be realized at a low temperature of 45° C., and after removing iron from the solution, an iron removal rate reaches 99.52%.

Embodiment 5: A method for continuously removing iron ions from a nickel-cobalt-manganese sulfuric acid solution at a low temperature by using a device for removing iron from a nickel-cobalt-manganese sulfuric acid solution comprised the following steps. a. Components of the solution (the nickel-cobalt-manganese sulfuric acid solution) to be subjected to iron removal were: Fe: 5.22 g/L, Co: 16.03 g/L, Mn: 3.47 g/L and Ni: 3.35 g/L. b. 127 g/L nickel carbonate slurry was prepared, and heat preservation was carried out at 45° C. c. An iron removal reactor 2 and an aging reactor 9 both had a diameter of 3 m, a height of 4 m and an effective volume of 24.72 m³. d. A mixer was started, the solution to be subjected to iron removal, compressed air and a manganese carbonate slurry were injected at the same time, a flow rate of the solution to be subjected to iron removal was 9.9 m³/h, and a flow rate of the compressed air was 31 m³/h. e. A temperature in the mixer was controlled to be 45° C., a temperature in the reactor was controlled to be 45° C., and a reaction PH value was controlled to be 3.11. f. After the iron removal reactor 2 was full, the solution flowed into the aging reactor 9, an automatic stone powder feeder 8 was started, and 4.6 kg of stone powder was controlled to be added every hour. g. After the aging reactor 9 was full, a filtering device was started for filtering, the device for removing iron reached a balance at the moment, and the materials could be continuously fed and discharged, thus realizing continuous production. h. Components of the iron-removed solution were analyzed and detected to be as follows: Fe: 0.0025 g/L, Co: 15.98 g/L, Mn: 3.13 g/L and Ni: 9.05 g/L.

In Embodiment 5, the problem that an existing technology for removing iron from solution must be used for removing iron at a high temperature of 85° C. or above is overcome, the iron removal of the solution can be realized at a low temperature of 45° C., an iron content in the solution is as high as 5.22 g/L, and after removing iron from the solution, an iron removal rate reaches 99.95%. When the iron content is high, this method can remove iron ions without adding additional oxidant, thus reducing a production cost.

Embodiment 6: A method for continuously removing iron ions from a nickel-cobalt-manganese sulfuric acid solution at a low temperature by using a device for removing iron from a nickel-cobalt-manganese sulfuric acid solution comprised the following steps. a. Components of the solution (the nickel-cobalt-manganese sulfuric acid solution) to be subjected to iron removal were: Fe: 0.77 g/L, Co: 22.03 g/L, Mn: 1.47 g/L and Ni: 4.31 g/L. b. 121 g/L cobalt carbonate slurry was prepared, and heat preservation was carried out at 45° C. c. An iron removal reactor 2 and an aging reactor 9 both had a diameter of 3 m, a height of 4 m and an effective volume of 24.72 m³. d. A mixer was started, the solution to be subjected to iron removal, compressed air and a manganese carbonate slurry were injected at the same time, a flow rate of the solution to be subjected to iron removal was 12.7 m³/h, and a flow rate of the compressed air was 30 m³/h. e. A temperature in the mixer was controlled to be 45° C., a temperature in the reactor was controlled to be 45° C., and a reaction PH value was controlled to be 3.13. f. After the iron removal reactor 2 was full, the solution flowed into the aging reactor 9, an automatic stone powder feeder 8 was started, and 5.2 kg of stone powder was controlled to be added every hour. g. After the aging reactor 9 was full, a filtering device was started for filtering, the device for removing iron reached a balance at the moment, and the materials could be continuously fed and discharged, thus realizing continuous production. h. Components of the iron-removed solution were analyzed and detected to be as follows: Fe: 0.0023 g/L, Co: 25.98 g/L, Mn: 1.19 g/L and Ni: 4.05 g/L.

In Embodiment 6, the problem that an existing technology for removing iron from solution must be used for removing iron at a high temperature of 85° C. or above is overcome, the iron removal of the solution can be realized at a low temperature of 45° C., an iron content in the solution is 0.77 g/L, and after removing iron from the solution, an iron removal rate reaches 99.70%. When the iron content is not high, this method is also applicable, and the process continuity is not affected.

Embodiment 7: A method for continuously removing iron ions from a nickel-cobalt-manganese sulfuric acid solution at a low temperature by using a device for removing iron from a nickel-cobalt-manganese sulfuric acid solution comprised the following steps. a. Components of the solution (the nickel-cobalt-manganese sulfuric acid solution) to be subjected to iron removal were: Fe: 3.04 g/L, Co: 35.03 g/L, Mn: 1.47 g/L and Ni: 14.31 g/L. b. 146 g/L sodium carbonate slurry was prepared, and heat preservation was carried out at 45° C. c. An iron removal reactor 2 and an aging reactor 9 both had a diameter of 3 m, a height of 4 m and an effective volume of 24.72 m³. d. A mixer was started, the solution to be subjected to iron removal, compressed air and a manganese carbonate slurry were injected at the same time, a flow rate of the solution to be subjected to iron removal was 11.3 m³/h, and a flow rate of the compressed air was 30 m³/h. e. A temperature in the mixer was controlled to be 45° C., a temperature in the reactor was controlled to be 45° C., and a reaction PH value was controlled to be 3.15. f. After the iron removal reactor 2 was full, the solution flowed into the aging reactor 9, an automatic stone powder feeder 8 was started, and 4.7 kg of stone powder was controlled to be added every hour. g. After the aging reactor 9 was full, a filtering device was started for filtering, the device for removing iron reached a balance at the moment, and the materials could be continuously fed and discharged, thus realizing continuous production. h. Components of the iron-removed solution were analyzed and detected to be as follows: Fe: 0.0043 g/L, Co: 34.88 g/L, Mn: 1.13 g/L and Ni: 14.05 g/L.

In Embodiment 7, the problem that an existing technology for removing iron from solution must be used for removing iron at a high temperature of 85° C. or above is overcome, the iron removal of the solution can be realized at a low temperature of 45° C., and after removing iron from the solution, an iron removal rate reaches 99.86%. The process adopts a calcium aging technology, with a good slag filtration performance, and there is no residual iron ion in the solution to affect an iron ion concentration in the solution.

The above are only the preferred embodiments of the present invention and are not intended to limit the present invention. For those skilled in the art, the present invention may have various modifications and changes. Any modification, equivalent substitution, improvement, etc. made within the spirit and principle of the present invention are included in the scope of protection of the present invention.

### INDUSTRIAL APPLICABILITY

The present invention has been put into industrial production and application, realizes the iron removal of the nickel-cobalt-manganese sulfuric acid solution at the low temperature of 40° C. to 45° C., and has the iron removal rate over 99.5%.

We claim:

1. A device for removing iron from a nickel-cobalt-manganese sulfuric acid solution, provided with an iron removal reactor and an aging reactor, a first stirrer being arranged in the iron removal reactor, a second stirrer being arranged in the aging reactor, and the iron removal reactor being connected with the aging reactor by an overflow port connecting pipe, wherein an iron removal reactor inner cylinder is arranged in the iron removal reactor, a mixing feed pipe and a carbonate solution feed pipe are arranged in an interlayer between the iron removal reactor and the iron removal reactor inner cylinder, a mixer is arranged at a top portion of the mixing feed pipe, a compressed air inlet and a feed inlet of a solution to be subjected to iron removal are arranged in the mixer, and an automatic stone powder feeder is arranged on the aging reactor.

2. The device for removing iron from the nickel-cobalt-manganese sulfuric acid solution according to claim 1, wherein the mixer is provided with a mixing bin, the mixing bin has a trapezoidal structure with a larger upper portion and a smaller lower portion, the lower portion of the mixing bin is provided with an electric heating portion, the compressed air inlet is arranged in a top portion of the mixing bin, the feed inlet of the solution to be subjected to iron removal is arranged in a side surface of the mixing bin, so that the solution to be subjected to iron removal is tangent to compressed air from the side surface, a diameter of an outlet in a bottom portion of the mixing bin is ½ of a diameter of the bottom portion of the mixing bin, the outlet in the bottom portion of the mixing bin is connected with the mixing feed pipe, and the mixing feed pipe penetrates through the electric heating portion.

3. The device for removing iron from the nickel-cobalt-manganese sulfuric acid solution according to claim 1, wherein a bottom end of the mixing feed pipe is 30 cm to 40 cm away from a bottom surface of the iron removal reactor, a direction of an outlet of the mixing feed pipe is tangent to a stirring direction of the stirrer, the carbonate solution feed pipe is 30 cm to 40 cm away from the bottom surface of the iron removal reactor, and a direction of an outlet of the carbonate solution feed pipe is tangent to the stirring direction of the stirrer.

4. The device for removing iron from the nickel-cobalt-manganese sulfuric acid solution according to claim 1, wherein the mixing feed pipe is symmetrically arranged with the carbonate solution feed pipe.

5. The device for removing iron from the nickel-cobalt-manganese sulfuric acid solution according to claim 1, wherein a height-diameter ratio of the iron removal reactor 2 is 1.0 to 2.5:1.

6. The device for removing iron from the nickel-cobalt-manganese sulfuric acid solution according to claim 1, wherein the stirrer is composed of a motor and a stirring vane, the stirring vane adopts a cross-shaped double-layer stirring blade, a diameter of the stirring blade is ⅓ of a diameter of the iron removal reactor, a lowermost stirring blade is 50 cm to 80 cm away from a bottom portion of the reactor, a distance between upper and lower stirring blades is 50 cm to 115 cm, the stirrer of the aging reactor is composed of a motor and a stirring vane, the stirring vane adopts a cross-shaped double-layer stirring blade, a diameter of the stirring blade is ⅓ of a diameter of the aging reactor, a lowermost stirring blade is 50 cm to 80 cm away from a bottom portion of the reactor, and a distance between upper and lower stirring blades is 50 cm to 115 cm.

7. The device for removing iron from the nickel-cobalt-manganese sulfuric acid solution according to claim 1, wherein the iron removal reactor inner cylinder is made into a cylindrical shape with open top and bottom portions, and fixed on an inner wall of the iron removal reactor by a support stirring frame, and a diameter of the inner cylinder is 70% to 80% of a diameter of the iron removal reactor.

8. A method for continuously removing iron ions from a nickel-cobalt-manganese sulfuric acid solution at a low temperature by using a device for removing iron from a nickel-cobalt-manganese sulfuric acid solution, comprising the following steps of:
a. preparing carbonate: preparing a carbonate solution or slurry first, wherein a carbonate concentration is 120 g/L to 240 g/L, and a temperature is controlled to be 40° C. to 45° C.;
b. injecting a solution to be subjected to iron removal: injecting a nickel-cobalt-manganese sulfuric acid solution to be subjected to iron removal and compressed air into an iron removal reactor through a mixer with a preheating device;
c. injecting the carbonate solution: adding the prepared carbonate solution or slurry into the iron removal reactor while injecting the nickel-cobalt-manganese sulfuric acid solution to be subjected to iron removal, and controlling a PH value of a process reaction to be 2.5 to 3.5;
d. carrying out a stirring reaction: when the solution to be subjected to iron removal and the carbonate solution are injected, stirring the mixture during injecting, controlling a process temperature to be 40° C. to 45° C., and after the reactor is full, making the reaction slurry flow into the aging reactor;
e. adding stone powder: after the reaction slurry enters the aging reactor, stirring the slurry, and then adding the stone powder through an automatic feed device; and
f. filtering the solution: filtering the solution after the aging reactor is full, wherein a filter residue is an iron slag, and a filtrate is the iron-removed nickel-cobalt-manganese sulfuric acid solution.

9. The method for continuously removing iron ions from the nickel-cobalt-manganese sulfuric acid solution at the low temperature by using the device for removing iron from the nickel-cobalt-manganese sulfuric acid solution according to claim 8, wherein in the step of injecting the iron solution to be subjected to iron removal, a flow rate of the solution is calculated according to a volume of the reactor by the following formula: flow rate=volume V of reactor m³/(2-5.5 hours), and a flow rate of the compressed air is 2 to 8 times that of the iron solution to be subjected to iron removal.

10. The method for continuously removing iron ions from the nickel-cobalt-manganese sulfuric acid solution at the low temperature by using the device for removing iron from the nickel-cobalt-manganese sulfuric acid solution according to claim 8, wherein an addition amount of the stone powder is 0.05 to 0.5 kg/m³ solution.

11. A nickel-cobalt-manganese sulfuric acid solution prepared by the method for continuously removing iron ions from the nickel-cobalt-manganese sulfuric acid solution at the low temperature by using the device for removing iron from the nickel-cobalt-manganese sulfuric acid solution according to claim 8.
